(19) United States
(12) Patent Application Publication
(10) Pub. No.: US 2010/0125746 A1
(43) Pub. Date: May 20, 2010

(54) METHOD AND SYSTEM FOR DETERMINING RELIABILITY PARAMETERS OF A TECHNICAL INSTALLATION

(76) Inventors: Jürgen Herrmann, Karlsbad (DE); Alexei Konnov, Karlsruhe (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/526,340

(22) PCT Filed: Feb. 8, 2008
(86) PCT No.: PCT/EP2008/051564

§ 371 Date: Jan. 15, 2010

(30) Foreign Application Priority Data
Feb. 8, 2007 (DE) 102007006365.4

(51) Int. Cl. G06F 11/07

(52) U.S. Cl. 714/1; 714/E11.029

(57) ABSTRACT

A method calculating reliability parameters of a technical installation is provided. The reliability parameters are calculated using a modified Markov minimum cut method in which probabilities of a plurality of components failing on account of a common cause and the property of a component or subassembly with self-diagnosis are concomitantly included in the calculation of the reliability parameters. The input parameters for the calculation model are determined from messages and/or subsystems in the technical installation or from the overall installation. The failure and repair rates calculated may be used to predict the reliability, availability, maintainability and safety of the technical installation.

### CROSS REFERENCE TO RELATED APPLICATIONS

This application is the US National Stage of International Application No. PCT/EP2008/051564, filed Feb. 8, 2008 and claims the benefit thereof. The International Application claims the benefits of German application No. 10 2007 006 365.4 DE filed Feb. 8, 2007, both of the applications are incorporated by reference herein in their entirety.

### FIELD OF INVENTION

The invention relates to a method and to a system for determining reliability parameters of a technical installation.

### BACKGROUND OF INVENTION

The development and operation of modern technical systems are inconceivable without appropriate reliability analysis. Diverse methods of reliability calculation are used nowadays in order to be able to make quantitative statements about the reliability of a technical system. The Markov minimum cut method is predominantly used in this connection.

The Markov minimum cut method is a combination of the method of the Markov processes and the minimum cut method. A minimum cut method is a special method for determining the reliability of a system or of components which considers the component failure states which lead to failure of the system.

A Markov process comprises Markov states (component or system states) and is identified by the property that the future development of the state at a given time is independent of the process's past. Changes or transitions in state are identified by constant transition rates.

The basic idea of the method of the Markov processes shall be illustrated using an example. An individual item under consideration A, which is being run, shall assume two states one after the other, namely state Z1: item intact, and state Z2: item failed. The failure rate of A is λ and assumed to be constant. The probabilities that the item A is in state Z1 or state Z2 at any desired time t is sought. The change in the probabilities of states Z1 and Z2 in terms of time may be calculated by the following system of equations:

$$\frac{d {P}_{1} ( t )}{d t} = - λ {P}_{1} ( t ) + μ {P}_{2} ( t ) \\ \frac{d {P}_{2} ( t )}{d t} = λ {P}_{1} ( t ) - μ {P}_{2} ( t ) \qquad ( 1 )$$

Here P₁(t)=probability that the item A is in state Z1 (=intact) at time t.
P₂(t)=probability that the item A is in state Z2 (=failed) at time t.
λ designates the failure rate and μ designates the repair rate of the item A.

λ and μ are also called transition rates because owing to λ and μ the states Z1 (item intact) and Z2 (item failed) of A merge. Equation (1) can also be written in the form of a matrix. The matrix which emerges from the system of equations given above

$$( \begin{matrix}- λ & μ \\ λ & - μ\end{matrix} ) \qquad ( 2 )$$

is also called the transition matrix. It should be noted that the sum of the elements vanishes in each column.

The system of equations (1) can also be clarified by a state diagram or a state graph. The circular symbols in FIG. 1 show the possible states Z1 and Z2 of item A, which is shown here as an individual circuit element. The state transitions possible within an interval (t, t+Δt) are identified by arrows with the associated transition rates λ and μ multiplied by the time interval Δt.

To apply a reliability determining method to a technical installation the latter must either be a logical structure in the form of a functional structure, a constructional plan or be in the form of reliability block diagrams (ZBD), and this structure then has to be analyzed. A reliability block diagram is an event diagram and answers the question about which components have to be working to fulfill the required function (whereby these components are essential to the function) and which components are allowed to fail (as they are redundant for example). The elements required to fulfill the function (subsystems, assemblies or components) are linked in series in a reliability block diagram. The elements which are allowed to fail, because they are redundant for example, are linked in parallel. A reliability block diagram can therefore exhibit significant differences from a component circuit diagram. A parallel circuit comprising a coil and a capacitor by way of example is shown as a series circuit in terms of reliability in a reliability block diagram. A reliability block diagram of a technical system must therefore always be developed with the aid of experts or expert knowledge. A reliability block diagram is not the only method for reliability analysis. A reliability model of a technical system can also be illustrated in the form of a fault tree or event tree as well as a state graph.

When analyzing a reliability block diagram of a system what is referred to as the top-down approach is used in which a hierarchical representation of a complex technical system is firstly broken down into subsystems, then into assemblies and finally into individual components. The highest decomposition level is always used as the starting point with the top-down approach. The corresponding, required function is formulated for each lower level and the appropriate state block diagram established. This takes place down to the lowest level for which the reliability details such as failure rate λ and repair rate μ are known for each individual component.

After establishing the reliability model by means of a state block diagram as in this case, the reliability calculation is made in a next step. In the process what are known as cuts through the system are determined. A cut is taken to mean a combination of component failure states which lead to failure of the system. A minimum cut is taken to mean a combination of component failure states which are necessary and sufficient for system failure via this cut. In a minimum cut the start of operation or repair of any component contained therein leads to cancelling of the cut, i.e. the system functions again.

To determine a minimum cut through a system having a number of components all combinations of component failures, which lead to interruptions in supply between the input and output, are checked by way of example within a reliability block diagram. The logic AND operation of the component failure states is called a cut or minimum cut. A distinction is made between minimum cuts of a different order according to the number of logic AND-related component failure states in a minimum step. The system failure occurs if at least one of the existing minimum cuts occurs. The minimum cuts within a system are conventionally determined on the basis of expert knowledge or by means of what is referred to as Failure Mode and Effect Analysis (FMEA). The theory states that only the third-order minimum cuts at most are significant to the reliability calculation.

In systems with stochastic-dependent components it can be assumed that the lowest-order minimum cuts determine system reliability. This means that the minimum steps can be modeled and calculated independently of each other via a Markov process.

An example shall accordingly be given for determining the reliability parameters of a technical installation according to the conventional Markov minimum cut method.

The reliability block diagram from FIG. 2 will be considered by way of example. It represents a bridge circuit having components A1 to A5 in terms of the reliability model. The bridge circuit is intended to be an entire system x. A plurality of minimum cuts can be made through the entire system x. To determine the minimum cuts components A1 to A5 are allowed to fail in all combinations and it is checked whether the system fails. A second-order minimum cut is marked as an example in FIG. 2 and is emphasized by the black-colored switching symbols of components A1 and A2. If components A1 and A2 fail then the entire system has failed. MS1=A1ΛA2 is therefore a minimum cut because the failure of both components is imperative for system failure via this cut. FIG. 2 illustrates additional potential minimum cuts M2, M3 and M4 of the entire system x. MS3 and MS4 are each third-order minimum cuts.

Minimum cut MS1 by way of example shall now be considered for the reliability calculation. The corresponding reliability parameters λ1 the failure rate and μ1 the repair rate are subsequently determined in this case for component A1. The corresponding failure rate λ1 and repair rate μ2 are likewise determined for component A2. The parameters can be taken from a table for example. Each value is indicated within a confidence interval. As a rule a normal distribution is assumed and a one-sided confidence interval of 95% selected.

It is then determined which states the minimum cut comprising 2 components can adopt. In this case it is N=4 states (Z1=A1, A2 intact; Z2=A1 intact, A2 failed; Z3=A1 failed, A2 intact; Z4=A1, A2 failed). The transition matrix is then determined by means of the known reliability parameters of the individual components λ1, λ2, μ1 and μ2. All transition rates cᵢₖ for the transition from state i to state k (k<=N) are given in this transition matrix. A system of equations for the changes in the probabilities of states 1 to 4 in terms of time is derived by means of the transition matrix. The individual probabilities P1(t), P2(t), P3(t) and P4(t) that the system is in state Z1, Z2, Z3 and Z4 respectively at time t are then determined from the system of equations. The probability P4(t) represents the probability for the considered minimum cut MS1=A1ΛA2 of the entire system in this case because both components A1 and A2 have failed.

The probabilities of all existing minimum cuts are added up to determine a reliability statement for the entire system x. In the example considered this means:

P_{Entiresystem}^{Failure}(t)=P₄^{MS1}(t)+P₄^{MS2}(t)+P₄^{MS3}(t)+P₄^{MS4}(t)=e^{-λEntiresystem}^{ₜ} (3)

The failure rate for the entire system is therefore derived from equation 3. The repair rate of the entire system may also be calculated.

The reliability parameters λ (given in 1/h) and μ are thus determined for the entire system.

Additional reliability parameters can be determined from the failure rate moreover, such as
the mean downtime MDT (given in h)
the mean time between failures MTBF (given in h)=reciprocal value of the failure rate

What are known as RAM values may also be calculated therefrom. (RAM=“Reliability, Availability, Maintainability”). Statements relating to the technical safety of an installation are often also required, i.e. safety if part of or all of the installation has failed. What are known as RAMS values are referred to in this case (S for “Safety”). The safety aspect is quantitatively detected by means of the probability of failure on demand PFD. RAMS values can be associated with individual components and assemblies but also with sub-systems and entire systems.

The reliability parameters of the individual components are usually taken from manufacturer data sheets or other handbooks. These are standards for provisional reliability analyses of industrial products. Examples thereof are the IEC standards 61708 and 61709 (IEC=“International Electro Technical Commission”), Siemens standard 29500 or the US Ministry of Defense Military Handbook MIL-HDBK-217F. The reliability calculation, which is based solely on these values substantiated in the standards or by the manufacturers, are accordingly purely theoretical predictions or prognoses.

As an alternative to this theoretical approach to reliability prognosis according to handbooks or standards the reliability parameters of the unit being considered (entire installation or subsystem) may also be determined on the basis of field data or in the field during operation of the unit being considered. Failures that occurred in the field, the total quantity of mounted assemblies or parameters of specific operating conditions for example are then detected as field data.

A comparison of a purely theoretical prediction with the values measured in the field leads to the result that the theoretical prediction is too pessimistic even if a confidence interval of 90-95% (i.e. lower risk) is applied for the value determined in the field. This is basically due to the fact that the RAM values of the individual components from the data sheets, standards or catalogues very often do not indicate the current status of the quality of the technology. Such an inaccuracy not only when calculating the RAM values of individual components but also as a consequence of an entire technical system could possibly signify a decisive drawback in terms of competition as the predictions determined in this way are often used as a basis for a sales department and as a guarantee for its offers. In extremely safety-relevant fields, such as in the nuclear sector, the highest requirements are placed on the RAM values of the prognosis, however. The predicted RAM values should be as close to reality as possible to be able to assess safety risks better.

### SUMMARY OF INVENTION

It is the object of the invention to disclose an improved method and system for determining reliability parameters of a technical installation.

These objects are achieved by the features of the independent claims. Advantageous developments are recited in the dependent claims respectively.

In contrast to the prior art reliability parameters of a technical installation are calculated according to the inventive method using a modified Markov minimum cut method in which probabilities of a plurality of components failing due to a common cause and diagnostic coverage are also taken into account. In other words, this means that on the one hand the simultaneous failure of a plurality of components due to a stochastic event and on the other hand the property of a component or assembly with self-diagnosis are concomitantly included in the calculation of the reliability parameters. The calculation model therefore receives newly determined transition rates in addition to the failure rates and repair rates of individual components or subsystems for detecting the newly considered factors.

This modification of the conventional Markov minimum cut method allows what are known as the RAM values of a technical installation to be predicted significantly more precisely and realistically. A failure rate of an entire system, determined according to the inventive method, provides a reliable statement close to the field value by way of which statements on safety may also be made. This creates safe operation management of a technical installation, a clear increase in availability as well as process optimization. In particular the calculation of predictions about the reliability of components and subsystems allows an installation to be maintained on a preventative basis. Therefore a direct intervention may be made in the technical process if determination of the failure rate of a component or failure probability justifies it. Crude design errors and weaknesses in terms of reliability can also be detected as early as in the planning phase.

Calculation of the reliability parameters can advantageously be incorporated in a computer platform which can itself in turn communicate and interact as an independent component with other systems of components of the technical installation. The method has a universal character and can therefore advantageously be applied to any technical installation irrespective of whether it is a power plant installation, an airplane, a medical installation or an industrial installation. In particular it can also be used for a control system which is constructed from hardware components and software components. Whereas statements on the subject of reliability of the software and hardware used in technical installations are conventionally based on evaluation of the goods returned in the case of hardware reliability, and on error messages and running times or retrievals of the software units being considered in the case of software reliability, the inventive method pursues a systematic and universal modeling and analysis approach with subsequent calculation of the reliability parameters. System reliability statements for both components of a technical installation, i.e. for both hardware and software, are therefore possible.

In one variant of the invention the reliability parameters are calculated during operation of the technical installation, or “online” as it were. For this purpose the calculating module for reliability calculation is either intermittently connected to a control system or is permanently incorporated in operation of the control system. A higher degree of precision is advantageously achieved therewith as the most current values are available for determining the input parameters. In the operating phase the precise RAM values allow development of an optimum and cost-effective maintenance strategy.

In a further variant the messages and/or data from individual components, subsystems of the technical installation and the entire installation correspond to field values which are obtained in a process-oriented manner from control systems of the technical installation or in the field. The most realistic predictions may be made using the field values. Qualitative assessments may also be derived from field data.

In a further variant the determined failure rates are subsequently checked or verified following calculation of a prediction by comparing them with the detected field data. If the calculated reliability parameters are not within a specified interval the reliability parameters are re-calculated in additional cycles, with adjustments being made in the model specifications used. The probabilities of a plurality of components failing due to a common cause and diagnostic coverage of a component can also be verified in the process.

### BRIEF DESCRIPTION OF THE DRAWINGS

The invention will be described in more detail hereinafter with reference to exemplary embodiments shown in the drawings, in which:

FIG. 1 shows a schematic diagram of a state graph of a component A (prior art),

FIG. 2 shows a schematic diagram to clarify the minimum cuts within a state block diagram (prior art),

FIG. 3 shows a schematic diagram of a cut comprising two assemblies E1 and E2,

FIG. 4 shows a schematic diagram of the inventive ACoRAM system for determining reliability parameters of a technical installation,

FIG. 5 shows a flow diagram to clarify an exemplary embodiment of the invention.

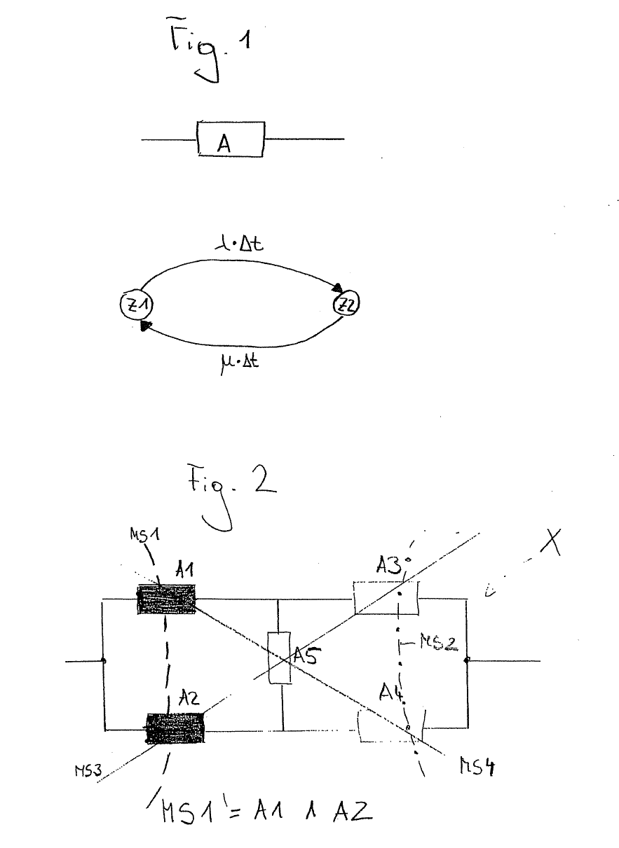

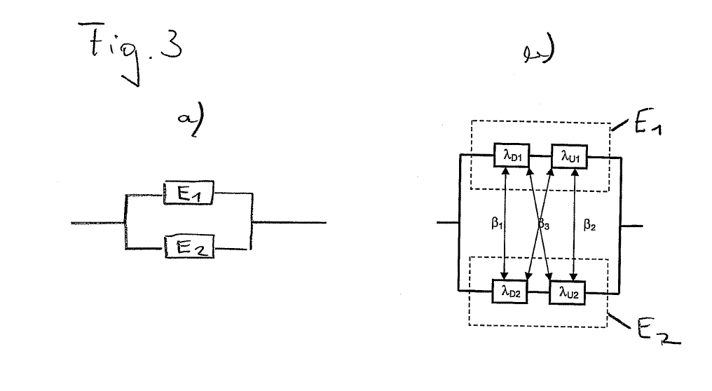

### DETAILED DESCRIPTION OF INVENTION

Failure of two assemblies due to a common cause (“common cause failure”, abbreviated to CCF) is defined according to standard IEC 61508-4 as follows: common cause failure is a failure which is the result of one or more event(s) which cause simultaneous failures of two or more separate channels in a multi-channel system, and lead to system failure.

The definition of a common failure should however be understood in the sense that a failure occurs within a time interval Δt. It is therefore sufficient if the second component fails while the first component is being repaired. Common cause failure can therefore also be regarded as a borderline case of a dependent failure within a short time interval. It is also true that CCF is not solely dependent on the failure rates of the individual components, rather it is solely dependent on the implementation of the technical system and its structure. CCF is also determined by the operating conditions (intensity) and the boundary conditions, such as stress factors, temperature, etc. and must be determined from the statistics. Thus for example high temperatures can lead to two components failing simultaneously. High atmospheric humidity or vibrations within the technical installation are also frequent causes of simultaneous component failure. All of these influences are conventionally detected in the CCF factor with the aid of standard IEC 61508-6 using lists of questions and tables included in the standard. Quantitative assessments of the CCF factor in the form of statistical tables are therefore provided in these standards.

CCF is quantitatively characterized by the failure rate λ_{CCF}. Here the following approximately applies:

λ_{CCF}≈β·λ

λ is the failure rate of the components being considered. β is a weighting factor. It matches a tabular value from the IEC 61508-6 standard.

The properties of a component with self-diagnosis shall be considered next. According to standard IEC 61511-1 the diagnostic coverage, abbreviated to DC, is defined as the portion of the many states which have been found by running a diagnostic test. Diagnostic coverage of a component or an assembly is the ratio of failure rates found to total failure rates of the component or assembly. Diagnostic tests can be automatic tests or be regularly triggered by user intervention using a time pattern. In the case of statistical determination of the failure rates of such components a distinction is made between found or detected failures with λ_{D} and unfound or undetected failures with λ_{U}.

Quantitatively the diagnostic coverage or DC factor is detected as follows:

$$D C = \frac{{n}_{D}}{n}$$

where n_{D}=number of found failures and

n=total number of failures

From this it follows: λ_{D}=DC·λ, and λ_{U}=(1−DC)·λ

The repair rates of an assembly with self-diagnosis are likewise divided into μ_{D} and μ_{U}.

In contrast to CCF the DC factor is independent of the structure of a technical system and always refers to an individual component or assembly.

Internal and external DC factors can be distinguished in the case of the DC factor moreover. While the internal DC factor DCᵢₙₜ characterizes the self-diagnosis of a component A itself, DCₑₓₜ detects the case where an external system or a different component B reports that component A is not working properly. It has been found that the eternal DC factor has much higher relevance to the statements on reliability than the internal DC factor DCᵢₙₜ.

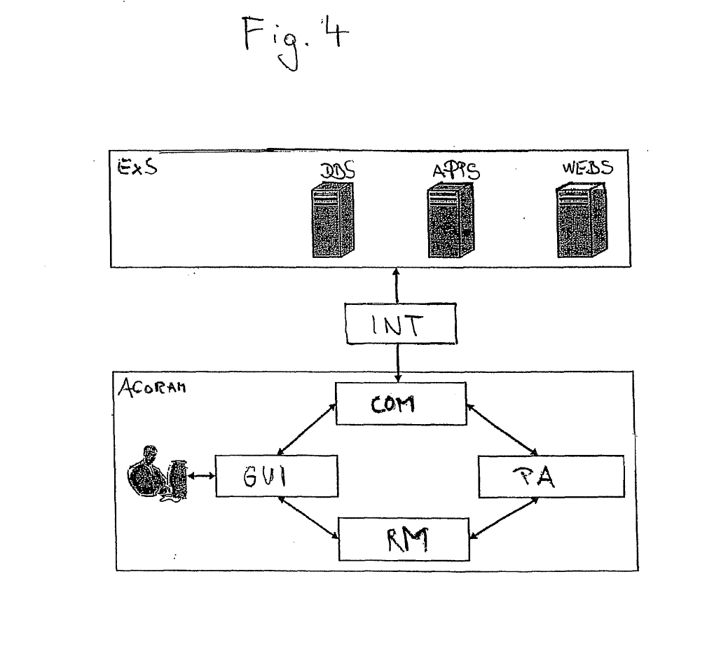

To clarify the inventive method a redundant, repairable system comprising two modules E1 and E2 with self-diagnosis will be considered hereinafter. A system of this kind is shown in FIG. 3a. The assemblies are not deemed to be identical.

It should be noted that each component with self-diagnosis exhibits two types of failure: found failures with failure rate λ_{D} and unfound failures with failure rate λ_{U}. In FIG. 3b each component (shown in broken lines in FIG. 3b) is symbolically replaced by two individual components respectively to clarify the different failure rates. The first assembly E1 is therefore characterized by the parameters λ_{D1}, λ_{U1}, μ_{D1}, μ_{U1} and assembly E2 by the parameters λ_{D2}, λ_{U2}, μ_{D2}, μ_{U2}. Each failure rate λ_{D}, λ_{U} is also split again into internal and external failure rates. To take account of common failures and therefore the CCF factors, FIG. 3b shows the possible combinations of the respective components which may fail together. The weighting factors (β₁, β₂, and β₃ include these possible combinations. All failure rates, repair rates, CCF factors and DC factors cited in this section form the input parameters for determining the transition matrix.

By taking account of the CCF and DC factors ten possible states emerge from the system state graphs in FIG. 3b for the entire system which represents a cut comprising two components or, in this case, assemblies. A state graph can be derived herefrom, from which, in turn, the modified transition matrix of the individual states and the corresponding system of differential equations are derived. The transition matrix includes the CCF factors and the DC factors. State 10 denotes the probability that a cut occurs and thus total failure of the system. In all remaining states the system remains intact.

The failure probability for the entire system is therefore calculated from the probability of state 10 occurring in FIG. 3a.

If the entire system includes a plurality of steps, then, analogously to the procedure illustrated in the introduction, the process is as follows

The transition matrix is calculated for each cut.

The probability of the cut being considered occurring is then calculated.

The failure probability for the entire system is calculated by adding all probabilities of the cuts being considered, and the failure rates and additional RAM values or RAMS values are determined from this.

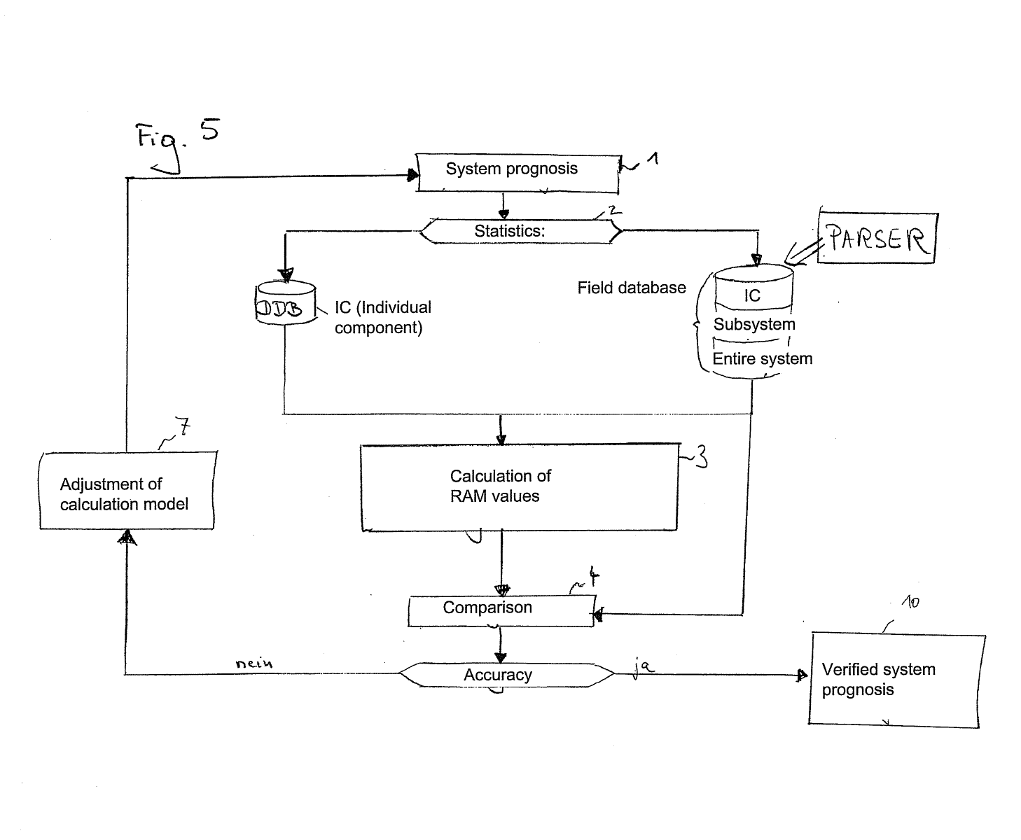

FIG. 4 shows a system for determining reliability parameters according to the inventive method. The ACoRAM system can be implemented in the form of a software application. In this embodiment the application has a modular architecture and is based on Microsoft .NET Framework. The individual modules COM, PA, RAM and GUI of the ACoRAM system support DCOM technology and standardized data transfer protocols.

The ACoRAM system comprises a first module COM which is designed for communication with databases and additional systems and components of the technical installation. The COM module primarily allows the ACoRAM system to cooperate with external systems ExS. Access to external database, application or WEB servers DBS, APPS and WEBS is ensured in this connection by means of standardized interfaces and data transfer protocols, for example TCP/IP protocols. In FIG. 4 the symbol INT represents existing interfaces, drivers or communication means as a connection between the external system and the ACoRAM system. Communication with the corresponding external systems via radio is also conceivable. In a process control installation the ACoRAM system could for example be connected to the existing bus system, so there is a direct connection to the process control and information system, the planning system, the engineering system, the diagnostic system or the automation system. Integration in existing process control systems is possible by appropriate adaptation of the interfaces.

Using communication module COM messages and/or data are read out from the external system, for example the process control system. These “raw data” in the form of installation information, process data, error messages and measured values are then forwarded to a second module, the parser module. The parser module allows syntactical analysis of the messages and/or data and conversion of the external system data format into the ACoRAM system data format. The required statistics on the read-out data are also compiled in the parser module PA.

Raw data and statistics can be stored in the ACoRAM system's own databases (not shown here). These data can be modified depending on which confidence intervals are adopted in the statistical distributions of the raw data. Structural representations of the technical installation (in terms of reliability), such as state block diagrams or state graphs, are also stored in the system's own database.

The input parameters for the reliability calculation model are determined from the collated information of the parser module and the databases. These are substantially failure rates of individual components, subsystems or the entire system, repair rates of individual components, subsystems or the entire system, failure rates due to a common cause, failure rates of components with self-diagnosis in which the failure has been detected, and failure rates of components with self-diagnosis in which the failure has not been detected.

The input parameters are forwarded to the calculating module RM in which, based on the Markov minimum cut method, the actual reliability parameter calculation is made by taking account of the failure probabilities due to a common cause and diagnostic coverage. A complete state graph or reliability block model of a minimum cut is firstly produced. A corresponding transition matrix is then formed. This is forwarded for example to an application server APPS of the external system ExS with mathematical software where a system of differential equations for the changes in probabilities of the individual states in terms of time is established from the transition matrix and is solved numerically.

The fourth module of this exemplary embodiment is an output unit GUI. It is a graphic user interface based on HTML technology. In conjunction with the WEB server WEBS it allows the operating system to be independent and several users to access the ACoRAM system simultaneously and provides a common user interface for depicting the calculated reliability parameters.

FIG. 5 [shows] a flow diagram to clarify the procedure for determining the reliability parameters if not just a prediction (prediction or prognosis) of the reliability parameters of an entire system is to be made but rather a verification as well, i.e. that, following calculation, a comparison is made between the calculated parameters and measured field data or field data determined from process data.

In one exemplary embodiment the reliability calculation is carried out in two phases:

Prognosis:

This is possible as early as in the planning phase of a process control system. The structure of the process control system is taken from the engineering system for this purpose, a corresponding model in the form of a reliability block diagram or state graph is formed and the reliability parameters of the assemblies are occupied by “standard values”.

Verification:

In this phase the values of the reliability parameters of the respective assemblies are determined from the process data or from the statistics with a confidence interval. These field values of the reliability parameters are introduced into the calculation model. The results from the verification phase are compared with the results from the prognosis phase.

One possible starting point for verification, which, as a rule, runs in a plurality of calculation cycles, is a system prognosis (box 1 in FIG. 5).

It is then checked whether a representative quantity of data and observations exist to determine the input parameters for the calculation model (box 2 in FIG. 5). This check substantially applies only to the database designated as the field database FieldDB here in which process data and measured values that are obtained in the field in a process-oriented manner are stored. If there are insufficient data and observations in the field database FieldDB the input parameters for the calculation model are taken from the default database. The default database DDB, in which standard values from handbooks and data sheets are stored for the failure rates, repair rates, DC and CC factors for individual components IC, has a constant dataset. The failure rates, repair rates, DC and CC factors are stored in the field database FieldDB ordered according to the structure or hierarchy of the technical installation for individual components IC, subsystems and the entire system. The field database FieldDB is connected to the parser module PA. Failure rates, repair rates, DC and CC factors, which have been taken from a process control system or a different external system ExS and have been converted into a system's own format, can thus also be stored in the field database. Before the actual reliability calculation (box 3, FIG. 5) it is firstly determined for which hierarchical level the reliability parameters should be determined. As an example it is assumed here that the failure rate for a subsystem of a technical installation should be calculated. The input parameters for the calculation model are always taken from the hierarchical level below. In accordance with this requirement the failure rates, repair rates, DC and CCF factors of the individual components included in the subsystem are taken as the input parameters from one or both databases in the example being considered. The calculation model then determines the sought failure rate of the subsystem for the cut or cuts of the subsystem being considered by means of the inventive modified Markov method. A comparison is then made between the theoretically calculated failure rates of the subsystem being considered and the “field value” of the subsystem failure rate taken from the field database (box 4, FIG. 5). With sufficient accuracy, i.e. if the two values are within a specified confidence interval, the theoretically calculated failure rate for the subsystem being considered is output (box 10, FIG. 5). If the values differ from each other too greatly, i.e. if the theoretically calculated value and the field value are not within a specific confidence interval, the calculation model has to be adjusted further (box 7, FIG. 5). The calculation model is substantially adjusted by changing the DC and CCF factors. As many additional factors such as ambient temperature, tensions within a component or other component properties are included in the CCF factor, they can be used as degrees of freedom for model adjustment. The calculation algorithm is run through again using the newly determined values of the DC and CCF factors.

1.-11. (canceled)

12. A method for determining reliability parameters of a technical installation, comprising:
forming a reliability model by establishing a logical structure of a subsystem of the technical installation using a top-down approach;
determining, within the logical structure, a plurality of relevant minimal steps up to a maximum of a third order;
determining the plurality of input parameters for all of the plurality of individual components of a cut and the corresponding rates are determined within each cut using a confidence interval;
determining a state transition matrix for each minimum cut using the plurality of input parameters;
creating a system of differential equations using the state transition matrix, from which a probability of an occurrence of the each minimum cut is determined; and
determining the failure probability, the failure rate and repair rate of the subsystem by adding all probabilities for the occurrence of a minimum cut,
wherein a plurality of input parameters for a reliability calculation model are determined from a message and/or data from a plurality of individual components, a plurality of subsystems of the technical installation, or the entire technical installation,
wherein the plurality of input parameters comprise at least the following parameters, failure rates of the plurality of individual components or subsystems, repair rates of the plurality of individual components or subsystems, failure rates due to a common cause, failure rates of components with self-diagnosis in which a failure has been detected, and failure rates of components with self-diagnoses in which the failure has not been detected, and
wherein the reliability parameters are calculated using a Markov minimum cut method.

13. The method as claimed in claim 12,
wherein the reliability parameters are calculated during an operation of the technical installation, and
wherein a message and/or data from a plurality of individual components, the plurality of subsystems of the technical installation or the entire installation are determined online.

14. The method as claimed in claim 12, wherein the message and/or the data from the plurality of individual components, the plurality of subsystems of the technical installation and the entire installation match field values which are obtained in a process-oriented manner from a control system of the technical installation or in the field.

15. The method as claimed in claim 12, wherein the plurality of input parameters are determined from default data from a database for the plurality of individual components of the technical installation.

16. The method as claimed in claim 12,
wherein the theoretically calculated reliability parameters calculated using the reliability calculation model are compared with previously determined field values, and
wherein the theoretically calculated reliability parameters are output if the theoretically calculated reliability parameters and the field values are within a specified precision interval.

17. The method as claimed in claim 12, further comprising:
comparing the theoretically calculated reliability parameters using the reliability calculation model with a previously determined field values;
making an adjustment of the reliability calculation model if the theoretically calculated reliability parameters and the field values are outside of the specified precision interval; and
calculating the reliability parameters with a subsequent comparison with field values until the theoretically calculated values and the field values are within a specified precision interval.

18. The method as claimed in claim 17, wherein the reliability calculation model is adjusted by changing the rates for detecting the failure probabilities due to a common cause and diagnostic coverage.

19. A system for determining the reliability parameters for a technical installation, comprising;
a first module for communication with databases and additional systems and a plurality of components of the technical installation for reading out a message and/or data from the technical installation;
a second module for determining a plurality of input parameters for a reliability calculation model from the read-out message and/or data, wherein the input parameters include at least failure rates of individual components or subsystems, repair rates of individual components or subsystems, failure rates due to a common cause, failure rates of components with self-diagnosis in which the failure has been detected, and failure rates of components with self-diagnosis in which the failure has not been detected;
a calculating module in which reliability parameters for an individual component, a subsystem or an entire system of the technical installation are calculated using the plurality of input parameters and a Markov minimum cut method which uses failure probabilities due to a common cause and diagnostic coverage,
wherein the Markov minimum cut method comprises:
forming a reliability model by establishing a logical structure of a subsystem of the technical installation using a top-down approach,
determining, within the logical structure of the technical installation, a relevant minimal step up to a maximum of a third order,
determining the plurality of input parameters for all of the plurality of components of the cut and the corresponding rates are determined within each cut using a confidence interval,
determining a state transition matrix for each minimum cut using the plurality of input parameters,
creating a system of differential equations using the state transition matrix, from which a probability of an occurrence of the individual minimum cuts is determined,
determining a failure probability, a failure rate and a repair rate of the subsystem by adding all probabilities for the occurrence of a minimum cut, and
wherein an output unit is used as a graphic user interface for depicting the calculated reliability parameters.

20. The system as claimed in claim 19, further comprising a first database in which empirical values of the plurality of input parameters are stored for the plurality of individual components, a plurality of subsystems and the entire system, and at least one additional database in which field values of the plurality of input parameters are stored for the plurality of individual components, the plurality of subsystems and the entire system, and
wherein the field values are an installation data and error messages from the technical installation.

21. The system as claimed in claim 19, wherein the technical installation is a control installation and a plurality of additional systems are a process control and information system, a planning system, a diagnostic system and/or an automation system.

22. The system as claimed in claim 19, wherein the system performs a method for determining reliability parameters of a technical installation, comprising:
forming a reliability model by establishing a logical structure of a subsystem of the technical installation using a top-down approach,
determining, within the logical structure of the technical installation, a relevant minimal step up to a maximum of a third order,
determining the plurality of input parameters for all of the plurality of components of the cut and the corresponding rates are determined within each cut using a confidence interval,
determining a state transition matrix for each minimum cut using the plurality of input parameters,
creating a system of differential equations using the state transition matrix, from which a probability of an occurrence of the individual minimum cuts is determined,
determining a failure probability, a failure rate and a repair rate of the subsystem by adding all probabilities for the occurrence of a minimum cut.
